(19) United States
(12) Patent Application Publication
(10) Pub. No.: US 2025/0219173 A1
(43) Pub. Date: Jul. 3, 2025

(54) CHARGE CONTROL DEVICE

(71) Applicant: HONDA MOTOR CO., LTD., Tokyo (JP)

(72) Inventors: Takeshi FUJINO, Saitama (JP); Naoki SAKASHITA, Saitama (JP); Hiroshi OGASA, Saitama (JP)

(21) Appl. No.: 18/851,071

(22) PCT Filed: Mar. 28, 2023
(86) PCT No.: PCT/JP2023/012637

§ 371 Date: Sep. 26, 2024

(30) Foreign Application Priority Data
Mar. 31, 2022 (JP) 2022-058653

(51) Int. Cl. H01M 10/48; H01M 10/052; H01M 10/46

(52) U.S. Cl. CPC H01M 10/488; H01M 10/052; H01M 10/46; H01M 10/486; H01M 2220/20

(57) ABSTRACT

This charge control device charges a lithium metal battery, which is a secondary battery in which lithium metal is used in a negative electrode, using a prescribed normal charge mode and a recovery charge/discharge mode. In the recovery charge/discharge mode, the lithium metal battery is temporarily discharged and then is charged for a longer time than in the normal charge mode. A detection unit detects a battery voltage, which is the voltage of the lithium metal battery. A calculation unit calculates the self-discharge rate of the lithium metal battery on the basis of a change in the battery voltage. A recording unit records a history of the self-discharge rate. An assessment unit assesses the need for charging by the recovery charge/discharge mode on the basis of a change in the self-discharge rate in time series in the history.

### TECHNICAL FIELD

The present invention relates to a charge control device for controlling charge of a secondary battery.

### BACKGROUND ART

In recent years, electric vehicles such as EVs and HEVs have come into widespread use from the viewpoint of reducing adverse effects on the global environment by reducing emission of carbon dioxide. Many of such electric vehicles are equipped with a lithium ion battery. The lithium ion battery includes a lithium ion-containing electrolytic solution between a positive electrode and a negative electrode, and a separator separating the electrolytic solution into a positive electrode side and a negative electrode side.

Currently, a majority of lithium ion batteries include carbon in the negative electrode. On the other hand, for the purpose of, for example, improving the energy density, use of lithium metal to form the negative electrode has been under study.

### CITATION LIST

### Patent Document

Patent Document 1: U.S. Pat. No. 10,727,545

### DISCLOSURE OF THE INVENTION

### Problems to be Solved by the Invention

A lithium metal battery including lithium metal in the negative electrode has the following problem to be solved, in comparison with a conventional lithium ion battery including carbon in the negative electrode.

In the conventional lithium ion battery, lithium ions in the electrolytic solution are stored between graphite layers during charge, and the stored lithium ions are released into the electrolytic solution during discharge. On the other hand, in the lithium metal battery, lithium ions in the electrolytic solution are precipitated in the form of lithium metal on the negative electrode during charge, and the lithium metal on the negative electrode is eluted into the electrolytic solution as lithium ions during discharge. Therefore, repeating charge and discharge causes deposition and elution of lithium metal to take place repeatedly.

Due to the repetition of deposition and elution, the lithium metal on the negative electrode, which has crystallized neatly and cleanly at a start of use of the lithium metal battery, may become porous and exhibit dendritic growth. In this case, a micro short circuit is developed between the negative electrode and the positive electrode, and the self-discharge rate of the lithium metal battery increases.

If the battery is left in this state, the development of short circuit progresses, and the self-discharge rate further increases. As a result, for example, the voltage of the lithium metal battery decreases quickly when an electric vehicle is in operation, whereby the possible cruising distance of the electric vehicle decreases.

As measures to solve the problem described above, it is conceivable to charge the lithium metal battery in a recovery charge/discharge mode in which the lithium metal battery is discharged once to a sufficient extent, that is, to an extent that lithium metal on the negative electrode is sufficiently eluted, and thereafter, the lithium metal battery is charged slowly for a long time to make lithium metal crystallize into larger crystals on the negative electrode.

However, the rate of development of a micro short circuit varies depending on various conditions related to the lithium metal battery: the negative electrode, the positive electrode, the electrolytic solution, the separator, charge/discharge conditions, etc. For this reason, it is difficult to determine at which timing the charge in the recovery charge/discharge mode should be performed, that is, it is difficult to determine whether the charge in the recovery charge/discharge mode is necessary on each occasion.

Specifically, for example, it is conceivable to determine that there is a micro short circuit and the charge in the recovery charge/discharge mode is necessary, on condition that a battery voltage as an open circuit voltage or the like of a lithium metal battery has become lower than a threshold value. However, for various batteries including the lithium metal battery, in general, an increase in the storage capacity results in that the open circuit voltage drops by a small amount despite formation of a micro short circuit path. For this reason, the voltage drop due to the micro short circuit is not sufficiently large in comparison with variation in battery voltage between lithium metal batteries, which makes it difficult to determine the micro short circuit and determine whether or not the charge in the recovery charge/discharge mode is necessary.

The present invention has been made in view of the above circumstances, and an object of the present invention is to accurately determine whether or not the charge in the recovery charge/discharge mode is necessary.

### Means for Solving the Problems

The present inventors have obtained the findings that whether or not the charge in the recovery charge/discharge mode is necessary can be accurately determined not based on a magnitude itself of a battery voltage or a magnitude itself of a self-discharge rate, but based on a change over time in the self-discharge rate, and have achieved the present invention. The present invention relates to a charge control device as described below in (1) to (9).

(1) A charge control device is for causing a lithium metal battery as a secondary battery including lithium metal in a negative electrode thereof to be charged in a predetermined normal charge mode and a recovery charge/discharge mode in which the lithium metal battery is once discharged and then charged for a longer time than in the normal charge mode. The charge control device includes:
a detector configured to detect a battery voltage as a voltage of the lithium metal battery;
a calculator configured to calculate a self-discharge rate of the lithium metal battery based on a change in the battery voltage;
a recorder configured to record a history of the self-discharge rate; and
a determiner configured to determine whether or not charge in the recovery charge/discharge mode is necessary based on a change over time in the self-discharge rate in the history.

According to the above feature, whether or not the charge in the recovery charge/discharge mode is necessary is determined not based on a magnitude itself of the battery voltage or a magnitude itself of the self-discharge rate, but based on a change over time in the self-discharge rate. Thus, the comparison is made with a past self-discharge rate, thereby making it possible to perform accurate determination even in a case where there is variation in the battery voltage between the lithium metal batteries. As described above, the above feature makes it possible to accurately determine whether or not the charge in the recovery charge/discharge mode is necessary.

(2) According to the charge control device described above in (1), the determiner determines that the charge in the recovery charge/discharge mode is necessary on condition that the self-discharge rate is increasing.

A lithium metal battery has a relatively high self-discharge rate at a start of use thereof, but the self-discharge rate gradually decreases because the electrodes and other components gradually become adapted after the start of use of the lithium metal battery, in many cases. However, when a micro short circuit is developed, the self-discharge rate begins increasing. Due to the above described feature, the timing at which the self-discharge rate begins increasing is detected, thereby making it possible to determined that the charge in the recovery charge/discharge mode has become necessary.

(3) The charge control device described above in (1) or (2) includes a switcher configured to allow switching from the normal charge mode to the recovery charge/discharge mode in response to the determiner determining that the charge in the recovery charge/discharge mode is necessary.

The above-described feature makes it possible to allow switching from the normal charge mode to the recovery charge/discharge mode only when the charge in the recovery charge/discharge mode is necessary.

(4) The charge control device described above in any one of (1) to (3) includes a maintenance attention prompter configured to send a maintenance attention signal in response to the determiner determining that the charge in the recovery charge/discharge mode is necessary.

Due to the above-described feature, when the charge in the recovery charge/discharge mode is necessary, the user or the like can be notified of that effect.

(5) The charge control device described above in any one of (1) to (4) includes a temperature detector configured to detect a battery temperature as a temperature of the lithium metal battery. The calculator calculates the self-discharge rate in a predetermined charge state at a predetermined temperature, based on the battery voltage detected and the battery temperature detected.

The above-described feature makes it possible to correct an error of the self-discharge rate caused by a difference in temperature. Thus, whether or not the charge in the recovery charge/discharge mode is necessary can be more accurately determined.

(6) According to the charge control device described above in any one of (1) to (5), the lithium metal battery is mounted in an electric vehicle, and the determiner determines whether or not the charge in the recovery charge/discharge mode is necessary based on a change in the self-discharge rate with respect to an increase in a distance travelled by the electric vehicle or an increase in an operation time of the electric vehicle.

The self-discharge rate tends to increase due to an increase in a distance travelled or an increase in the operation time. In this respect, the determiner determines whether or not the charge in the recovery charge/discharge mode is necessary based on a change in the self-discharge rate with respect to an increase in the distance travelled or an increase in the operation time, thereby enabling transition to the recovery charge/discharge mode. In comparison with a case where the necessity of the charge in the recovery charge/discharge mode is determined based on a change in the self-discharge rate with respect to a simple increase in a length of time elapsed from the start of use of a lithium metal battery, the above feature makes it possible to more accurately determine whether or not the charge in the recovery charge/discharge mode is necessary, thereby enabling transition to the recovery charge/discharge mode.

(7) The charge control device described in any one of (1) to (6) includes
a temperature detector configured to detect a battery temperature as a temperature of the lithium metal battery;
a table in which a discharge current value as a current value during discharge in the recovery charge/discharge mode and a discharge time as a time required for the discharge are stored for each of divisions of a plurality of the self-discharge rates and for each of divisions of a plurality of the battery temperatures; and
a setter configured to set the discharge current value and the discharge time for the recovery charge/discharge mode, based on the self-discharge rate calculated by the calculator, the battery temperature detected by the temperature detector, and the table.

An optimum discharge current value and an optimum discharge time depend on the self-discharge rate and the battery temperature. In this respect, the setter sets the discharge current value and the discharge time based on the table, in accordance with the self-discharge rate and the battery temperature. This feature makes it easy to set the optimum discharge current value and the optimum discharge time.

(8) The charge control device described in any one of (1) to (7) includes a temperature controller configured to allow the charge in the recovery charge/discharge mode on condition that a temperature of the lithium metal battery is equal to or higher than a predetermined temperature.

From the viewpoint of protection of the lithium metal battery, the discharge in the recovery charge/discharge mode is preferably performed at a predetermined temperature or higher. In this respect, the temperature controller allows the charge in the recovery charge/discharge mode on condition that the temperature of the lithium metal battery is equal to or higher than the predetermined temperature, thereby making it possible to efficiently protect the lithium metal battery.

(9) The charge control device described in any one of (1) to (8) includes a maintenance attention prompter configured to send a maintenance attention signal in response to the determiner determining that the charge in the recovery charge/discharge mode is necessary, and cancel the maintenance attention signal in response to completion of discharge in the recovery charge/discharge mode.

Due to the above-described feature, the maintenance attention signal is automatically sent and canceled by the maintenance attention prompter.

### Effects of the Invention

As described above, the feature described above in (1) makes it possible to accurately determine whether or not the charge in the recovery charge/discharge mode is necessary. Furthermore, the features described above in (2) to (9), which cite (1), provide the respective additional effects.

### BRIEF DESCRIPTION OF THE DRAWINGS

FIG. 1 is a diagram illustrating a configuration of an electric vehicle according to a first embodiment;

FIG. 2 is a graph illustrating an example of changes in a battery voltage;

FIG. 3 is a graph illustrating an example of changes in a self-discharge rate; and

FIG. 4 is a flowchart illustrating a flow of charge in a recovery charge/discharge mode.

### PREFERRED MODE FOR CARRYING OUT THE INVENTION

Embodiments of the present invention will be described below with reference to the drawings. However, it should be noted that the present invention is not limited to the following embodiments in any way, and can be appropriately modified and implemented without departing from the spirit of the present invention.

### First Embodiment

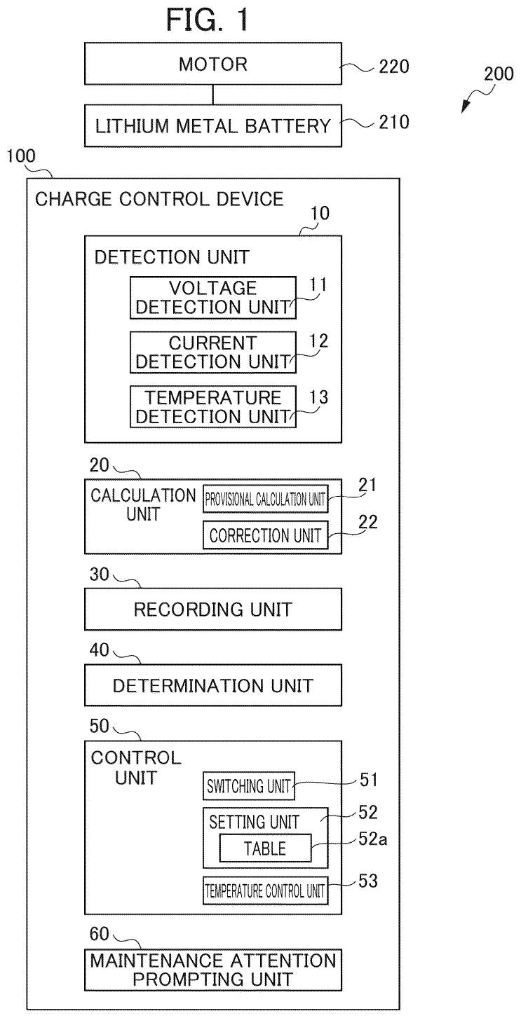

FIG. 1 is a diagram illustrating a configuration of an electric vehicle 200 according to the present embodiment. The electric vehicle 200 includes a motor 220 that serves as a power source of the electric vehicle 200, a lithium metal battery 210 as a secondary battery that supplies electric power to the motor 220, and a charge control device 100 that controls charge of the lithium metal battery 210.

The lithium metal battery 210 includes a positive electrode, a negative electrode, an electrolytic solution disposed between the positive electrode and the negative electrode, and a separator that separates the electrolytic solution into a positive electrode side and a negative electrode side.

The positive electrode includes layers containing a positive electrode active material, a binder, and a conductive additive. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}COᵣO₂ (p+q+r=1), and lithium manganese oxide (LiMn₂O₄). Another example of the positive electrode active material is hetero-element-substituted Li—Mn spinel represented by Li₁₊ₓMn_{2-x-y}M_{y}O₄ (x+y=2, and M is at least one selected from Al, Mg, Co, Fe, Ni, or Zn). Further examples of the positive electrode active material include lithium titanate (an oxide containing Li and Ti), lithium metal phosphate (LiMPO₄, where M is at least one selected from Fe, Mn, Co, or Ni), and the like. Preferably, Li₁Ni_{0.8}Co_{0.1}Mn_{0.1}O₂ (NCM811) is used as the positive electrode active material.

The negative electrode includes a negative electrode base material such as a negative electrode current collector and a lithium foil, and a lithium metal layer formed by depositing lithium metal on the negative electrode base material. The lithium metal battery 210 has a very high energy density in comparison with a conventional lithium ion battery.

The electrolytic solution includes an organic solvent and an electrolyte. As a first organic solvent for the organic solvent, 1,1,2,2-tetrafluoro-1-(2,2,2-trifluoroethoxy) ethane, which is a fluorine-substituted chain hydrocarbon, or a hydrofluoroether such as methyl nonafluoroisobutyl ether and methyl nonafluorobutyl ether, can be used, for example. As a second organic solvent, 1,2-dimethoxyethane (DME), ethylene carbonate (EC), propylene carbonate (PC), sulfolane (SL), dimethyl carbonate (DMC), diethyl carbonate (DEC), ethyl methyl carbonate (EMC), or the like can be used, for example. The first organic solvent and the second organic solvent can be used in combination.

The electrolyte is a source of lithium ions serving as charge transfer media, and includes a lithium salt. As the lithium salt, at least one selected from the group consisting of LiFSI, LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂ (LiFSI), and LiBC₄O₈ can be used. Among them, LiFSI is preferred to be used as the electrolyte.

The lithium metal battery 210 supplies electric power to the motor 220 during power running in which, for example, the electric vehicle 200 is accelerated or a vehicle speed is maintained on an uphill or the like. On the other hand, the lithium metal battery is charged with electric power supplied from the motor 220 during regeneration in which, for example, the electric vehicle 200 is decelerated or, acceleration is suppressed on a downhill or the like.

The charge control device 100 performs charge control when the lithium metal battery 210 is charged by charging equipment. Specifically, the charge control device 100 causes the lithium metal battery 210 to be charged in a predetermined normal charge mode and a predetermined recovery charge/discharge mode.

The charge in the normal charge mode is performed by charging equipment installed at the user's home, a charging spot, or the like. In the normal charge mode, CC charge in which charge with a constant charging current is performed is followed by CV charge in which charge with a constant charging voltage is performed.

The charge in the recovery charge/discharge mode is performed by charging equipment installed at a car dealer or the like. In the recovery charge/discharge mode, a control program to perform maintenance for recovering the capacity, resistance, and self-discharge performance of the lithium metal battery 210 and/or maintenance for preventing deterioration of the performance of the lithium metal battery 210 is executed. Specifically, in the recovery charge/discharge mode, a charge/discharge control program, which is different from a program for limiting a current during traveling of the vehicle and/or during charge, and/or a battery temperature control program, which is different from a program for controlling a temperature during traveling of the vehicle and/or during charge, are/is executed.

In detail, in the recovery charge/discharge mode, the lithium metal battery 210 is sufficiently discharged, and thereafter, is charged for a longer time than in the normal charge mode. Specifically, in the recovery charge/discharge mode, after the discharge, CC charge is performed, and thereafter, CV charge is performed. The charging current for the CC charge in the recovery charging/discharging mode is smaller than the charging current for the CC charge in the normal charge mode. More specifically, in the recovery charge/discharge mode, the lithium metal battery 210 is sufficiently discharged at about 0.2 C to 1 C until the SOC decreases to about 20% to 0%, and then, charged at about 0.05 C to 0.3 C until the SOC reaches 100%.

The charge control device 100, which is mainly constituted by an ECU including a CPU, a RAM, a ROM, and the like, includes a detection unit 10, a calculation unit 20, a recording unit 30, a determination unit 40, a control unit 50, and a maintenance attention prompting unit 60.

The detection unit 10 includes a voltage detection unit 11, a current detection unit 12, and a temperature detection unit 13. The voltage detection unit 11 has a voltage sensor, and detects a “battery voltage” as a voltage across the terminals of the lithium metal battery 210. The current detection unit 12 has a current sensor, and detects a “battery current” as a current passing through the lithium metal battery 210. The temperature detection unit 13 has a temperature sensor, and detects a “battery temperature” as a temperature of the lithium metal battery 210.

The calculation unit 20 calculates a “self-discharge rate Ds” as a self-discharge rate of the lithium metal battery 210 in a predetermined charge state such as a fully charged state at a predetermined temperature such as 25° C., based on the battery voltage and the battery temperature detected by the detection unit 10. The self-discharge rate Ds may be, for example, an amount of decrease in voltage per unit time, i.e., a voltage decrease rate, or an amount of decrease in stored power per unit time, i.e., a power storage decrease rate.

The calculation unit 20 includes a provisional calculation unit 21 and a correction unit 22. The provisional calculation unit 21 calculates a “provisional self-discharge rate Dst” as a self-discharge rate in a predetermined charge state at a current temperature of the battery, based on a change in the battery voltage Vb. The correction unit 22 calculates the above-mentioned self-discharge rate Ds by correcting the provisional self-discharge rate Dst based on the current temperature of the battery.

The recording unit 30 records a history of the self-discharge rate Ds by sequentially storing the self-discharge rate Ds or information related to the self-discharge rate Ds.

The determination unit 40 determines whether or not the charge in the recovery charge/discharge mode is necessary, based on changes over time in the self-discharge rate Ds recorded in the history. Hereinafter, a state where “the charge in the recovery charge/discharge mode is necessary” is referred to simply as “the recovery charge/discharge is necessary”. The determination unit 40 determines that the recovery charge/discharge is necessary on, for example, condition that a change in the self-discharge rate Ds with respect to an increase in a distance travelled by the electric vehicle 200 or an increase in an operation time of the electric vehicle 200 in the latest predetermined period can be determined to be positive even in consideration of an error or the like, that is, on condition that it is determined that the self-discharge rate Ds is increasing, even in consideration of the error or the like. The reason for the determination will be described later.

The control unit 50 carries out control such that the charge in the normal charge mode is performed in a case where the determination unit 40 does not determine that the recovery charge/discharge is necessary, and the charge in the recovery charging/discharging mode is performed in a case where the determination unit 40 determines that the recovery charge/discharge is necessary. Specifically, the control unit 50 includes a switching unit 51, a setting unit 52, and a temperature control unit 53. The switching unit 51 sets a recovery charge/discharge flag to ON on condition that the determination unit 40 determines that the recovery charge/discharge is necessary. As a result, switching from the normal charge mode to the recovery charge/discharge mode is allowed.

The setting unit 52 sets a “discharge current value” as a current value for discharge in the recovery charge/discharge mode and a “discharge time” as a time required for the discharge. Specifically, the setting unit 52 includes a table 52a in which a discharge current value and a discharge time are stored for each of divisions of a plurality of the self-discharge rates Ds and for each of divisions of a plurality of the battery temperatures. The setting unit 52 sets the discharge current value and the discharge time based on the self-discharge rate Ds calculated by the calculation unit 20, the battery temperature detected by the temperature detection unit 13, and the table 52a.

The temperature control unit 53 allows the charge in the recovery charge/discharge mode on condition that the battery temperature is equal to or higher than a predetermined temperature, e.g., equal to or higher than 20° C. More specifically, the temperature control unit 53 allows the charge in the recovery charge/discharge mode on condition that the battery temperature is within a predetermined temperature range of, for example, 20° C. to 25° C.

The maintenance attention prompting unit 60 sends a maintenance attention signal in response to the determination unit 40 determining that the recovery charge/discharge is necessary. The maintenance attention signal may be a visually appealing signal sent by means of, for example, a maintenance attention lamp, an auditorily appealing signal, or a combination thereof. Examples of the auditorily appealing signal include emitting a maintenance attention prompting sound and announcing that the recovery charge/discharge is necessary, at a predetermined timing such as a timing when the main power of the electric vehicle 200 is turned on. The maintenance attention prompting unit 60 cancels the maintenance attention signal in response to completion of the discharge in the recovery charge/discharge mode.

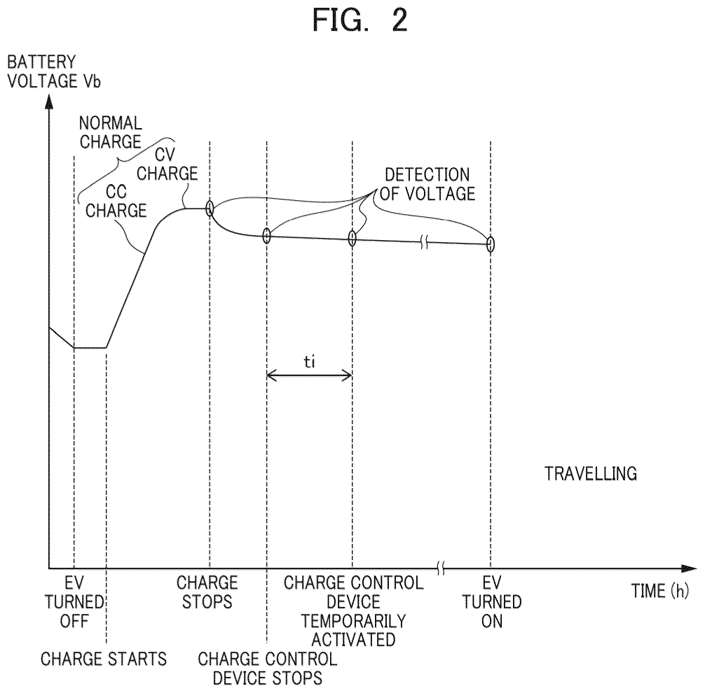

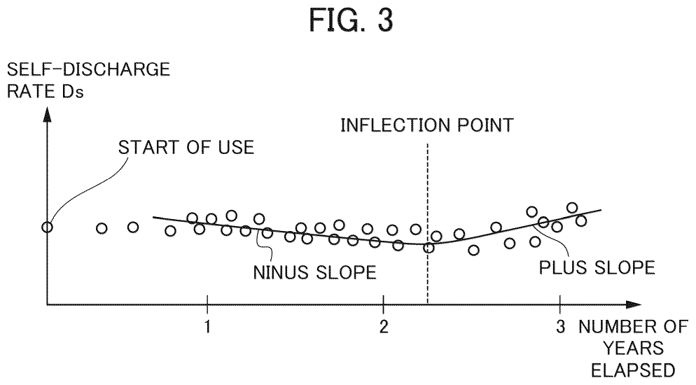

Next, with reference to FIGS. 2 and 3, the reason why the determination unit 40 determines that the recovery charge/discharge is necessary based on an increase in the self-discharge rate Ds will be described.

FIG. 2 is a graph illustrating an example of changes in the battery voltage Vb. During the CC charge in the normal charge mode, the battery voltage Vb increases in accordance with storing a predetermined amount of power per unit time. During the subsequent CV charge, as the battery voltage Vb approaches the full charge voltage, the charge rate slows, so that the battery voltage Vb gradually increases to reach the full charge voltage. When the full charge voltage is reached, the charge is stopped, and the voltage detection unit 11 detects an open circuit voltage as the battery voltage Vb.

After the stop of charge, the charge control device 100 again detects an open circuit voltage as the battery voltage Vb by the voltage detection unit 11, and then stops operating. Thereafter, even if the power of the lithium metal battery 210 is not consumed, the battery voltage Vb gradually decreases due to self-discharge. During this period, the charge control device 100 is temporarily activated every predetermined time ti, e.g., every several hours, and detects an open circuit voltage as the battery voltage Vb by the voltage detection unit 11. The calculation unit 20 calculates the self-discharge rate Ds based on the changes in the open circuit voltage. Thereafter, when the main power switch of the electric vehicle 200 is turned on by the user, the battery voltage Vb decreases as the power of the lithium metal battery 210 is consumed.

FIG. 3 is a graph illustrating an example of changes in the self-discharge rate Ds of the lithium metal battery 210. The lithium metal battery 210 has a relatively high self-discharge rate Ds at a start of use, but the self-discharge rate Ds gradually decreases because the electrodes and other components gradually become adapted after the start of use of the lithium metal battery 210. However, as charge and discharge are repeatedly performed, the lithium metal on the negative electrode, which has crystallized neatly and cleanly at the start of use of the battery, becomes porous and exhibits dendritic growth, whereby a micro short circuit is developed between the negative and positive electrodes. Due to progress of the micro short circuit, the self-discharge rate Ds begins increasing. Based on this, the determination unit 40 determines that the recovery charge/discharge is necessary based on the increase in the self-discharge rate Ds, as described above. Specifically, the determination unit 40 determines that the recovery charge/discharge is necessary at the timing corresponding to an inflection point at which the slope of the self-discharge rate Ds changes from minus to plus.

The horizontal axis in FIG. 3 represents the number of years elapsed, but it is preferable that the horizontal axis represents a distance travelled by the electric vehicle 200 or an operation time of the electric vehicle 200. That is, according to a preferred aspect, whether or not the charge in the recovery charge/discharge mode is necessary is determined based on a slope representing changes in the self-discharge rate Ds with respect to an increase in the distance travelled or an increase in the operation time. Therefore, the determination unit 40 adopts the preferred aspect, as described above.

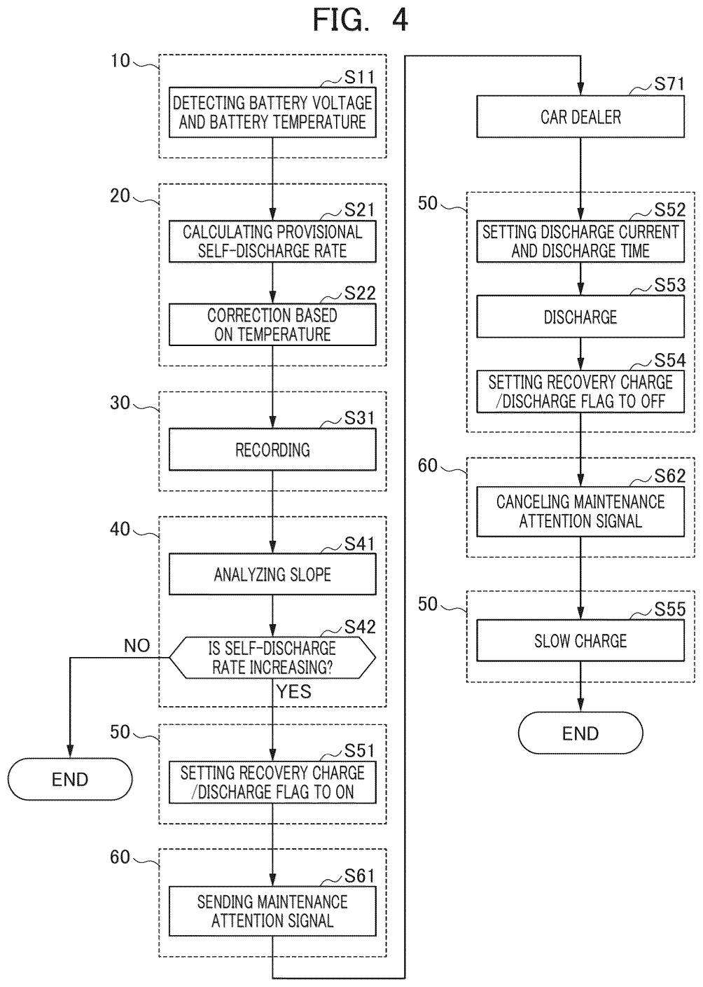

FIG. 4 is a flowchart illustrating a flow of the charge in the recovery charge/discharge mode. The flow shows a case where the charge mode is set to the normal charge mode at the initial setting. In the flow, first, in Step S11, the detection unit 10 detects a battery voltage Vb and a battery temperature.

Next, in Step S21, the provisional calculation unit 21 of the calculation unit 20 calculates a provisional self-discharge rate Dst based on a change in the battery voltage Vb detected. Next, in Step S22, the correction unit 22 of the calculation unit 20 calculates a self-discharge rate Ds by correcting the provisional self-discharge rate Dst based on the battery temperature.

Next, in Step S31, the recording unit 30 stores the self-discharge rate Ds. In this way, a history of the self-discharge rate Ds is sequentially stored.

Next, in Step S41, the determination unit 40 calculates a slope of the self-discharge rate Ds based on the history of the self-discharge rate Ds. Next, in Step S42, the determination unit 40 determines whether or not the slope is a plus slope, that is, whether or not the self-discharge rate Ds is increasing. When a negative determination is made in Step S42, the flow ends without switching the charge mode from the normal charge mode to the recovery charge/discharge mode: that is, the flow ends while the charge mode remains in the normal charge mode. On the other hand, when a positive determination is made in Step S42 is positive, the process proceeds to Step S51.

In Step S51, the switching unit 51 of the control unit 50 sets the recovery charge/discharge flag to ON. As a result, the charge in the recovery charge/discharge mode is allowed. In subsequent Step S61, the maintenance attention prompting unit 60 sends a maintenance attention signal. Steps S51 and S61 may be performed in the reversed order or simultaneously.

Next, in Step S71, the user brings the electric vehicle 200 to a car dealer. At this time, since the recovery charge/discharge flag is ON, a worker at the car dealer can carry out the charge in the recovery charge/discharge mode by performing a predetermined operation. Then, the charge is actually started.

In the recovery charge/discharge mode, first, in Step S52, the setting unit 52 of the control unit 50 sets a discharge current value and a discharge time. Next, in Step S53, the control unit 50 causes the lithium metal battery to discharge, based on the set discharge current value and the set discharge time. It should be noted that in this process, the charge in the recovery charge/discharge mode is started by the temperature control unit 53 on condition that the battery temperature is within a predetermined temperature range, e.g., from 20° C. to 25° C. The discharge in this step makes most of the lithium metal layer on the negative electrode of the lithium metal battery 210 elute into the electrolytic solution.

Upon completion of the discharge, the switching unit 51 sets the recovery charge/discharge flag to OFF in Step S54, and the maintenance attention prompting unit 60 cancels the maintenance attention signal in Step S62. Next, in Step S55, the control unit 50 causes the lithium metal battery to be charged for a longer time than in the case of the normal charge mode, that is, at a lower rate than in the case of the normal charge mode. As a result, lithium metal crystallizes into larger crystals on the negative electrode. After completion of the charge, the flow ends.

The features and effects of the present embodiment are summarized as follows.

The determination unit 40 determines whether or not the charge in the recovery charge/discharge mode is necessary, not based on a magnitude itself of the battery voltage Vb or a magnitude itself of the self-discharge rate Ds, but based on changes over time in the self-discharge rate Ds. Thus, the comparison is made with a past self-discharge rate Ds, thereby making it possible to perform accurate determination even in a case where there is variation in the battery voltage Vb between the lithium metal batteries 210.

A lithium metal battery 210 has a relatively high self-discharge rate Ds at a start of use, but the self-discharge rate Ds gradually decreases because the electrodes and other components gradually become adapted after the start of use of the lithium metal battery 210, in many cases. However, when a micro short circuit is developed, the self-discharge rate Ds begins increasing. In this respect, the determination unit 40 determines that the recovery charge/discharge is necessary on condition that the self-discharge rate Ds is increasing. This feature makes it possible to be aware of the occurrence of a micro short circuit based on the fact that the self-discharge rate Ds that has decreased begins increasing.

The switching unit 51 allows switching from the normal charge mode to the recovery charge/discharge mode in response to the determination unit 40 determining that the recovery charge/discharge is necessary. This feature makes it possible to allow switching from the normal charge mode to the recovery charge/discharge mode only when the charge in the recovery charge/discharge mode is necessary.

In response to the determination unit 40 determining that the recovery charge/discharge is necessary, the maintenance attention prompting unit 60 sends a maintenance attention signal. Due to this feature, when the charge in the recovery charge/discharge mode is necessary, the user or the like can be notified of that effect.

Based on the detected battery voltage Vb and the detected battery temperature, the calculation unit 20 calculates a self-discharge rate Ds in a predetermined charge state such as a fully charged state at a predetermined temperature such as 25° C. Therefore, an error of the self-discharge rate Ds caused by a difference in the battery temperature can be corrected. This feature makes it possible to more accurately determine whether or not the charge in the recovery charge/discharge mode is necessary.

The self-discharge rate Ds tends to increase due to an increase in a distance travelled by the electric vehicle 200 or an increase in the operation time of the electric vehicle 200. In this respect, the determination unit 40 determines whether or not the charge in the recovery charge/discharge mode is necessary based on a change in the self-discharge rate with respect to an increase in the distance travelled or an increase in the operation time. This feature makes it possible to more accurately determine whether or not the charge in the recovery charge/discharge mode is necessary, in comparison with a case where the necessity of the charge in the recovery charge/discharge mode is determined based on a change in the self-discharge rate Ds with respect to a simple increase in a length of time elapsed from the start of use of a lithium metal battery.

An optimum discharge current value and an optimum discharge time for the discharge in the recovery charge/discharge mode depend on the self-discharge rate Ds and the battery temperature. In this respect, the setting unit 52 sets the discharge current value and the discharge time based on the self-discharge rate Ds calculated by the calculation unit, the battery temperature detected by the temperature detection unit 13, and the table 52a. This feature makes it easy to set the optimum discharge current value and the optimum discharge time.

From the viewpoint of protection of the lithium metal battery 210, the discharge in the recovery charge/discharge mode is preferably performed at a predetermined temperature or higher. In this respect, the temperature control unit 53 allows the charge in the recovery charge/discharge mode on condition that the battery temperature is equal to or higher than the predetermined temperature, thereby making it possible to efficiently protect the lithium metal battery 210.

The maintenance attention prompting unit 60 sends a maintenance attention signal in response to the determination unit 40 determining that the recovery charge/discharge is necessary, and cancels the maintenance attention signal in response to completion of the discharge in the recovery charge/discharge mode. Thus, the maintenance attention signal is automatically sent and canceled by the maintenance attention prompting unit 60.

### [Modifications]

The above embodiment can be modified as follows, for example. The determination unit 40 may determine that the recovery charge/discharge is necessary at a timing slightly earlier or slightly later than the inflection point. Specifically, for example, the determination unit 40 may determine that the recovery charge/discharge is necessary on condition that the slope of the self-discharge rate Ds is larger than a threshold value that is slightly smaller or slightly larger than zero.

### EXPLANATION OF REFERENCE NUMERALS

10: Detection unit
11: Voltage detection unit
13: Temperature detection unit
20: Calculation unit
21: Provisional calculation unit
22: Correction unit
30: Recording unit
40: Determination unit
50: Control unit
51: Switching unit
52: Setting unit
52a: Table
53: Temperature control unit
60: Maintenance attention prompting unit
100: Charge control device
200: Electrical vehicle
210: Lithium metal battery
Vb: Battery voltage
Ds: Self-discharge rate

What is claimed is:

1. A charge control device for causing a lithium metal battery as a secondary battery including lithium metal in a negative electrode thereof to be charged in a predetermined normal charge mode and a recovery charge/discharge mode in which the lithium metal battery is once discharged and then charged for a longer time than in the normal charge mode, the charge control device comprising:
a detector configured to detect a battery voltage as a voltage of the lithium metal battery;
a calculator configured to calculate a self-discharge rate of the lithium metal battery based on a change in the battery voltage;
a recorder configured to record a history of the self-discharge rate; and
a determiner configured to determine whether or not charge in the recovery charge/discharge mode is necessary based on a change over time in the self-discharge rate in the history.

2. The charge control device according to claim 1, wherein
the determiner determines that the charge in the recovery charge/discharge mode is necessary on condition that the self-discharge rate is increasing.

3. The charge control device according to claim 1, comprising:
a switcher configured to allow switching from the normal charge mode to the recovery charge/discharge mode in response to the determiner determining that the charge in the recovery charge/discharge mode is necessary.

4. The charge control device according to claim 1, comprising:
a maintenance attention prompter configured to send a maintenance attention signal in response to the determiner determining that the charge in the recovery charge/discharge mode is necessary.

5. The charge control device according to claim 1, comprising:
a temperature detector configured to detect a battery temperature as a temperature of the lithium metal battery, wherein
the calculator calculates the self-discharge rate in a predetermined charge state at a predetermined temperature, based on the battery voltage detected and the battery temperature detected.

6. The charge control device according to claim 1, wherein
the lithium metal battery is mounted in an electric vehicle, and
the determiner determines whether or not the charge in the recovery charge/discharge mode is necessary based on a change in the self-discharge rate with respect to an increase in a distance travelled by the electric vehicle or an increase in an operation time of the electric vehicle.

7. The charge control device according to claim 1, comprising:
a temperature detector configured to detect a battery temperature as a temperature of the lithium metal battery;
a table in which a discharge current value as a current value during discharge in the recovery charge/discharge mode and a discharge time as a time required for the discharge are stored for each of divisions of a plurality of the self-discharge rates and for each of divisions of a plurality of the battery temperatures; and
a setter configured to set the discharge current value and the discharge time for the recovery charge/discharge mode, based on the self-discharge rate calculated by the calculator, the battery temperature detected by the temperature detector, and the table.

8. The charge control device according to claim 1, comprising:
a temperature controller configured to allow the charge in the recovery charge/discharge mode on condition that a temperature of the lithium metal battery is equal to or higher than a predetermined temperature.

9. The charge control device according to claim 1, comprising:
a maintenance attention prompter configured to send a maintenance attention signal in response to the determiner determining that the charge in the recovery charge/discharge mode is necessary, and cancel the maintenance attention signal in response to completion of discharge in the recovery charge/discharge mode.
